(19) United States
(12) Patent Application Publication
(10) Pub. No.: US 2022/0411583 A1
(43) Pub. Date: Dec. 29, 2022

(54) LIQUID PROCESSABLE BISMALEIMIDE-TRIAZINE RESINS

(71) Applicant: ROLLS-ROYCE plc, London (GB)

(72) Inventors: Robert James EREDALE, Derby (GB); Ian HAMERTON, Derby (GB)

(73) Assignee: ROLLS-ROYCE plc, London (GB)

(21) Appl. No.: 17/355,288

(22) Filed: Jun. 23, 2021

(51) Int. Cl. C08G 73/06

(52) U.S. Cl. CPC C08G 73/0644

(57) ABSTRACT

A curable resin composition including a first bismaleimide compound, a second bismaleimide compound which is different from the first bismaleimide compound, and a cyanate ester monomer. A liquid processible bismaleimide-triazine resin is provided by curing the resin composition. A method of preparing the liquid processible bismaleimide-triazine resin is also disclosed.

### STATEMENT REGARDING A PRIOR DISCLOSURE BY THE INVENTORS

The inventors disclosed a dissertation entitled “Solvent-free, liquid processable bismaleimide-triazine resins” on http://research-information.bristol.ac.uk on Jun. 25, 2021 until Jul. 6, 2021. The content of this dissertation is incorporated herein by reference.

### BACKGROUND

### Field of the Disclosure

The present disclosure concerns bismaleimide-triazine (BT) compositions, bismaleimide-triazine resins and their use in various sectors including aerospace, satellites, and microelectronics. They can for example be used in the manufacture of composites, coatings, adhesives, and other speciality chemical materials.

### Description of the related art

Bismaleimide-triazine (“BT”) resins are thermoset polymers composed of two or more bismaleimide (BMI) and cyanate ester (CE) components. BT resins are used in the microelectronics industry in the manufacture of printed circuit boards (PCBs), which are used in a wide range of electronic devices including mobile phones. They are also used in radomes for antenna systems as they do not absorb or alter radar or microwave signals that are sent to the receiver.

The development and widespread use of BT resins has been marred by their high cost and poor processability. In conventional BT resin systems, either high temperatures (e.g. >150° C.) or harmful, high-boiling solvents (e.g. N,N-dimethylformamide, N-methylpyrrolidinone or N,N-dimethylacetamide) are required in order to allow the fabrication of composite products.

It is known to prepare BT resins from 1,1-bis(4-cyanato-phenyl)ethane instead of cyanate esters but such BT resins were found to be inhomogeneous, prone to BMI sedimentation, and incapable of being processed as liquid BT systems in the absence of one or more solvents. Some BT resins are prepared from materials that pose carcinogenicity risks.

It is therefore desirable to provide bismaleimide-triazine compositions and bismaleimide-triazine resins with improved processability.

### SUMMARY OF THE DISCLOSURE

In a first aspect the present disclosure provides a curable resin composition comprising:

(a) a first bismaleimide compound; (b) a second bismaleimide compound, which is different from the first bismaleimide compound; and (c) a cyanate ester monomer.

In some embodiments the first bismaleimide compound is a compound of formula I:

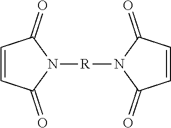

where R is —Ar¹—R¹—Ar²—, wherein Ar¹ is C₆-C₁₀-aryl, R¹ is C₁-C₁₀-alkylene, and Ar² is C₆- C₁₀-aryl.

In some embodiments the first bismaleimide compound is a compound of formula I where R is —Ar¹—R¹—Ar²—, wherein Ar¹ is phenylene, R¹ is C₁-C₄-alkylene, and Ar² is phenylene.

In some embodiments the first bismaleimide compound is a compound of formula la:

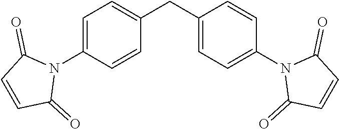 [SMILES: O=C1C=CC(=O)N1c1ccc(Cc2ccc(N3C(=O)C=CC3=O)cc2)cc1]

In some embodiments the second bismaleimide compound is a compound of formula I where R is —R²—Ar³—R³—, wherein R² is C₁-C₁₀-alkylene, Ar³ is C₆-C₁₀-aryl, and R³ is C₁-C₁₀-alkylene.

In some embodiments the second bismaleimide compound is a compound of formula I where R is —R²—Ar³—R³—, wherein R² is C₁-C₄-alkylene, Ar³ is phenylene, and R³ is C₁-C₄-alkylene.

In some embodiments the second bismaleimide compound is a compound of formula IIa:

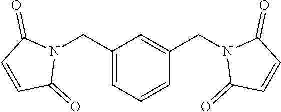 [SMILES: O=C1C=CC(=O)N1Cc1cccc(CN2C(=O)C=CC2=O)c1]

In some embodiments the first bismaleimide compound and the second bismaleimide compound are present in a eutectic mixture.

In some embodiments the cyanate ester monomer is a compound of formula III:

N≡C—O—Ar⁴—R⁴—Ar⁵—O—C≡N

wherein Ar⁴ is C₆-C₁₀-aryl, R⁴ is C₁-C₁₀-alkylene, and R⁵ is C₁-C₁₀-alkylene.

In some embodiments R⁵ is —C(H)(C₁-C₄-alkyl)-.

In some embodiments R⁵ is —C(H)(CH₃)—.

In some embodiments the cyanate ester monomer is a compound of formula IIIa:

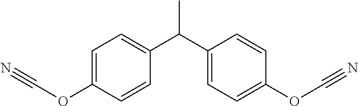 [SMILES: CC(c1ccc(OC#N)cc1)c1ccc(OC#N)cc1]

In some embodiments the curable resin composition is free of any solvent.

In some embodiments the curable resin composition further comprises a catalyst.

In some embodiments the catalyst is bis(acetylacetonato)copper(II).

In a second aspect the present disclosure provides a liquid processible bismaleimide-triazine resin comprising a cured curable resin composition of the first aspect.

The resin typically has a low viscosity (e.g. <1000 mPa·s) at temperatures lower than about 100° C., making liquid composite moulding feasible at temperatures below about 50° C., and in some cases at ambient temperature.

In a third aspect the present disclosure provides a method of preparing a liquid processible bismaleimide-triazine resin of the first aspect, the method comprising the steps of: (a) mixing a first bismaleimide compound, a second bismaleimide compound that is different from the first bismaleimide compound, and a cyanate ester monomer, to form a curable resin composition of the first aspect; and (b) curing the curable resin composition to form a liquid processible bismaleimide-triazine resin of the second aspect.

In some embodiments the curable resin composition is cured at about 150° C. to about 170° C.

In some embodiments the curable resin composition is cured at about 160° C.

In some embodiments the curable resin composition is cured at about 150° C. to about 170° C. for about 1 hour, about 190° C. to about 210° C. for about 3 hours, and about 250 ° C. to about 270° C. for about 1 hour.

In some embodiments the curable resin composition is cured at about 160° C. for about 1 hour, at about 200° C. for about 3 hours, and at about 260° C. for about 1 hour.

The term “bismaleimide (BMI) compound” as used herein means a compound of the following formula I where R is hydrocarbon group, e.g. an alkylene group or an aryl group.

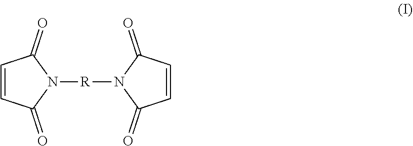

The term “C₁-C₁₀-alkylene group” as used herein means a straight chain or branched alkylene that contains one to ten carbon atoms, for example, methylene, ethylene, trimethylene, methylethylene, tetramethylene, —CH(CH₃)CH₂CH₂—, —CH₂CH(CH₃)CH₂—, straight or branched pentylene, straight or branched hexylene, straight or branched heptylene, straight or branched octylene, straight or branched nonylene, or straight or branched decylene. C₁-C₁₀-alkylene may be C₁-C₄ alkylene, e.g. ethylene or methylethylene.

The term “C₆-C₁₀-aryl group” as used herein means a monovalent carbocyclic aromatic group that contains 6 to 10 carbon atoms and which may be, for example, a monocyclic group such as phenyl or a bicyclic group such as naphthyl. C₆-C₁₀-aryl may be C₆-C₈-aryl, e.g. phenyl.

The term “cyanate ester” as used herein means a molecule in which the hydrogen atom of a phenolic OH group has been substituted with a cyanide (—C≡N) group.

The term “eutectic mixture” as used herein means a homogeneous or at least substantially homogeneous mixture of two or more components that melts or solidifies at a single temperature that is lower than the melting point of one or more of components.

The term “processible” as used herein means, e.g. with respect to a resin, being capable of being combined with fibres using liquid composite moulding techniques including resin infusion and resin transfer moulding.

Other than in the operating examples, or where otherwise indicated, all numbers expressing quantities of ingredients used herein are to be understood as modified in all instances by the term “about”.

Throughout this specification and in the claims that follow, unless the context requires otherwise, the word “comprise” or variations such as “comprises” and “comprising”, will be understood to imply the inclusion of a stated integer or group of integers but not the exclusion of any other stated integer or group of integers.

The skilled person will appreciate that except where mutually exclusive, a feature described in relation to any one of the above aspects may be applied mutatis mutandis to any other aspect. Furthermore, except where mutually exclusive any feature described herein may be applied to any aspect and/or combined with any other feature described herein.

### BRIEF DESCRIPTION OF THE DRAWINGS

Embodiments will now be described by way of example only, with reference to the Figures, in which:

FIG. 1 is a graph showing the results of an example (Example 4) conducted to optimise the wt. % ratio of the first bismaleimide compound and the second bismaleimide compound in the composition used to prepare a liquid processible bismaleimide-triazine resin of the present disclosure.

FIG. 2 is a graph that shows dynamic scanning calorimetry (DSC) plots for a eutectic mixture (E) of bismaleimidodiphenylmethane (MDAB) and m-xylylenebismaleimide (MXBI) and its corresponding constituent monomers (Example 5).

FIG. 3 is a graph that shows thermogravimetric analysis (TGA) plots for a eutectic mixture (E) of bismaleimidodiphenylmethane (MDAB) and m-xylylenebismaleimide (MXBI) and its corresponding constituent monomers (Example 6).

FIG. 4 is a graph that shows dynamic scanning calorimetry (DSC) plots for uncured resin compositions with differing contents of cyanate ester and eutectic mixture (E) of bismaleimidodiphenylmethane (MDAB) and m-xylylenebismaleimide (MXBI) (Example 8).

FIG. 5 is a graph that shows viscosity (DSC) plots for uncured resin compositions with differing contents of cyanate ester and eutectic mixture (E) of bismaleimido-diphenylmethane (MDAB) and m-xylylenebismaleimide (MXBI) (Example 9).

FIG. 6 is a graph that shows dynamic scanning calorimetry (DSC) plots for selected resin compositions (Example 10).

FIG. 7 is a graph that shows dynamic mechanical thermal analysis data as plots of storage modulus against temperature for a selection of resin blends (Example 10).

FIG. 8 is a graph that shows dynamic mechanical thermal analysis data as plots of storage modulus against temperature for a selection of resin blends cured using a modified cure cycle (Example 10).

FIG. 9 is a graph that shows thermogravimetric analysis (TGA) plots for a selection of cured liquid processible bismaleimide-triazine resins (Example 11).

### DETAILED DESCRIPTION OF THE DISCLOSURE

Aspects and embodiments of the present disclosure will now be discussed with reference to the accompanying drawings. Further aspects and embodiments will be apparent to those skilled in the art.

The present disclosure concerns a curable resin composition, a liquid processible, bismaleimide-triazine resin, and a method of preparing a liquid processible bismaleimide-triazine resin.

The curable resin composition of the present disclosure comprises: (a) a cyanate ester monomer; (b) a first bismaleimide compound; and (c) a second bismaleimide compound, which is different from the first bismaleimide compound.

Each component of this composition will now be described in turn.

First Bismaleimide Compound

The curable resin composition of the present disclosure includes a first bismaleimide compound.

In some embodiments the first bismaleimide compound is a compound of formula I:

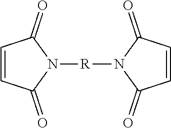

where R is —Ar¹—R¹—Ar²—, wherein Ar¹ is C₆-C₁₀-aryl, R¹ is C₁-C₁₀-alkylene, and Ar² is C₆- C₁₀-aryl.

In some embodiments the first bismaleimide compound is a compound of formula I where R is —Ar¹—R¹—Ar²—, wherein Ar¹ is phenylene, R¹ is C₁-C₄-alkylene, and Ar² is phenylene.

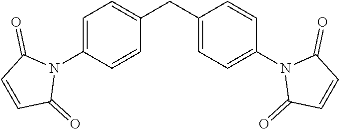 [SMILES: O=C1C=CC(=O)N1c1ccc(Cc2ccc(N3C(=O)C=CC3=O)cc2)cc1]

a compound of formula Ia:

The compound of formula la is bismaleimidodiphenylmethane (MDAB), which is commercially available from Evonik Industries AG.

Second Bismaleimide Compound

The curable resin composition of the present disclosure includes a second bismaleimide compound. The second bismaleimide compound is different from the first bismaleimide compound.

In some embodiments the second bismaleimide compound is a compound of formula I:

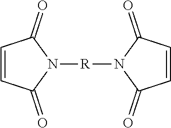

where R is —R²—Ar³—R³—, wherein R² is C₁-C₁₀-alkylene, Ar³ is C₆-C₁₀-aryl, and R³ is C₁-C₁₀-alkylene.

In some embodiments the second bismaleimide compound is a compound of formula I where R is —R²—Ar³—R³—, wherein R² is C₁-C₄-alkylene, Ar³ is phenylene, and R³ is C₁-C₄-alkylene.

In some embodiments the second bismaleimide compound is a compound of formula IIa:

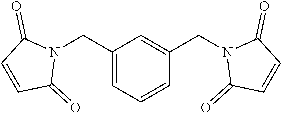 [SMILES: O=C1C=CC(=O)N1Cc1cccc(CN2C(=O)C=CC2=O)c1]

The compound of formula Ila is m-xylylenebismaleimide (MXBI), which is commercially available from Evonik Industries AG.

Eutectic Mixture of Bismaleimide Compounds

In some embodiments the curable resin composition of the present disclosure includes the first bismaleimide compound and the second bismaleimide compound in a eutectic mixture i.e. a homogeneous mixture of the first bismaleimide compound and the second bismaleimide compound that melts or solidifies at a single temperature that is lower than the melting point of the first bismaleimide compound or the second bismaleimide compound.

In other words, a mixture is eutectic when the ratio of the components is such that the melting point is at a minimum. Broadly speaking the eutectic ratio can be found by mixing different blends with varying ratios of the different components to identify which has the lowest melting point. This is achieved by melting the two components together. Ideally the compounds should have differing structures, for example so that they pack differently, perhaps one compound disrupting the packing of the other compound, thus preventing or reducing crystallisation. The compounds may have different solubility parameters, typically quantified by differing Hildebrand solubility coefficients.

Pure bismaleimide compounds are generally crystalline compounds with high melting points due to the close packing facilitated by their polar maleimide rings. Providing the bismaleimide compounds as a eutectic mixture typically reduces this crystallinity.

It is advantageous for the curable resin composition to include a eutectic mixture of a bismaleimide compound and a second bismaleimide compound as it enables the curable resin composition to be processed at lower temperatures

Processing typically involves filling a mould to produce a monolith or impregnating a fibrous reinforcement, e.g. carbon fibre fabric, before heating in an oven/autoclave to effect cure to form a hard plastic or carbon fibre reinforced polymer (CFRP). It is typically more energy efficient, cheaper and quicker to be able to process a material at a lower temperature and therefore generally more productive.

For example a curable resin composition of the present disclosure comprises 1,1-bis(4-cyanatophenyl)ethane (LECy) and a eutectic mixture of bismaleimidodiphenylmethane (MDAB) and m-xylylenebismaleimide (MXBI). Bismaleimidodiphenylmethane has a melting point of 124° C. and m-xylylenebismaleimide has a melting point of 157° C. however a eutectic mixture of bismaleimidodiphenylmethane and m-xylylenebis-maleimide has a melting point of 107° C. This means that this mixture can be manufactured at 110° C. rather than 160° C.

The use of a eutectic mixture of bismaleimidodiphenylmethane (MDAB) and m-xylylenebismaleimide (MXBI) improves its processing window, i.e. the temperature gap observed between melting and the onset of polymerisation, by about 50° C. compared with either of the single monomers.

Cyanate Ester Monomer

The curable resin composition of the present disclosure includes a cyanate ester monomer.

As used herein, the term “cyanate ester” refers to a molecule in which the hydrogen atom of a phenolic OH group has been substituted with a cyanide (-CEN) group.

Any suitable cyanate ester may be used. In some embodiments the cyanate ester is a low viscosity cyanate ester i.e. displaying a bulk viscosity lower than about 100 mPa s at the intended processing temperature. The cyanate ester is typically in liquid form.

In some embodiments the cyanate ester monomer is a compound of formula III:

N≡C—O—Ar⁴—R⁴—Ar⁵—O—C≡N

wherein Ar⁴ is C₆-C₁₀-aryl, R⁴ is C₁-C₁₀-alkylene, and R⁵ is C₁-C₁₀-alkylene.

In some embodiments R⁵ is a branched C₁-C₁₀-alkylene. As a branched C₁-C₁₀-alkylene, R⁵ is typically asymmetrical.

In some embodiments R⁵ is —C(H)(C₁-C₄-alkyl)-.

In some embodiments R⁵ is —C(H)(CH₃)—.

In some embodiments the cyanate ester monomer is a compound of formula IIIa:

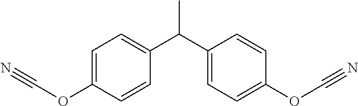 [SMILES: CC(c1ccc(OC#N)cc1)c1ccc(OC#N)cc1]

The compound of formula IIIa is 1,1-bis(4-cyanatophenyl)ethane (LECy), which is commercially available from Lonza Group AG.

Curable Resin Composition

The curable resin composition comprises the aforementioned first bismaleimide compound, second bismaleimide compound, cyanate ester monomer.

In some embodiments the curable resin composition is free of any solvent, or at least substantially free of any solvent. This is desirable for several reasons. It reduces safety risks for those who manufacture and otherwise work with the materials. It is environmentally advantageous as it means using fewer chemicals, being less reliant on petroleum- based feedstocks, and minimising chemical waste. From a processing perspective, it avoids the need to remove any solvent from the final product thereby simplifying processing, maximising yield, and minimising the formation of voids in the product that could weaken the product. Furthermore, solvent systems generally cannot be processed by liquid composite moulding.

The curable resin composition of the present disclosure can be formulated to fine-tune one or more properties of the resin produced by curing it. Such properties may include, for example, the process ability/fluidity/viscosity prior to curing, thermo-mechanical properties (e.g. glass-transition temperature), thermal and thermo-oxidative stability, reactivity, extremely low dielectric constant, and flame retardancy moisture absorption, and/or erosion performance.

In some embodiments the curable resin composition includes a catalyst in order to lower the cure initiation temperature. This is useful when low temperature processing is needed. However the components of the curable resin composition of the present disclosure typically cure to high degrees of conversion, in the absence of catalyst. From an environmental perspective it is generally desirable to avoid the use of a catalyst, particularly a catalyst that includes a transition metal. It also reduces the potential for galvanic corrosion or water absorption in the final product.

The catalyst, when desired or necessary, catalyses the polymerisation of the cyanate ester and one or both maleimide groups of the first bismaleimide compound and/or the second bismaleimide compound.

The catalyst can take many forms suitable for the required purpose.

In some embodiments the catalyst is Cu^{II}(AcAc)₂ i.e. bis(acetylacetonato)-copper(II) or copper acetylacetonate or chelates or carboxylates of other first row transition elements including, but not limited to manganese, cobalt, iron, nickel, or zinc.

The catalyst may be suspended in a liquid epoxy resin, e.g. EPIKOTE™ Resin 828 epoxy resin, which is a medium viscosity liquid epoxy resin produced from bisphenol A resin and epichlorohydrin that is commercially available from Hexion Inc. Other materials are suitable e.g. 1,1-bis(4-cyanatophenyl)ethane (LECy), provided that they are liquid, compatible with the transition element complex, and capable of reacting with the cyanate ester in the blend.

Liquid Processible Bismaleimide-Triazine Resin

The present disclosure provides a liquid processible bismaleimide-triazine resin that comprises a cured from of the curable resin composition of the present disclosure.

The curing process can be performed by any art known curing method. Such methods may include autoclaving, hot pressing, or liquid moulding.

The resin comprises thermoset polymers with low viscosities (e.g. about <1000 mPa·s) at temperatures lower than about 100° C., making liquid composite moulding feasible at temperatures below about 50° C., and in some cases at ambient temperature. The low viscosity and fluidity of the blend facilitates suitably wetting and suitably covering the fibres when impregnating the fibrous reinforcement in the manufacture of laminates/composites.

When compared with the industry standard, the commercially available Mitsubishi BT2110 resin, the physical and mechanical properties of the cured resins of the present disclosure are favourable with the potential to achieve superior glass transition temperature (Tg), superior storage modulus, and/or superior thermal stability. This is described in more detail in the Examples.

The liquid processible bismaleimide-triazine resin of the present disclosure have desirable electrical, thermal, and other properties that enable useful applications in various industries including the aerospace and electronics industries.

In the aerospace industry for example, liquid processible bismaleimide-triazine resins of the present disclosure can be combined with a fibrous reinforcement, such as carbon or glass, to produce composite materials, which possess properties that provide weight, strength and other advantages over more traditionally used metals such as steel and aluminium.

In the electronics industry for example, liquid processible bismaleimide-triazine resins of the present disclosure can be used as dielectric resins, laminating varnishes, and laminate substrates for printed wiring boards, printed circuit boards, multi-chip modules, and radomes.

Method of Preparing a Liquid Processible Bismaleimide-Triazine Resin

The present disclosure also provides a method of preparing the aforementioned liquid processible bismaleimide-triazine resin from the aforementioned curable resin composition. The method comprises the steps of: (i) mixing a first bismaleimide compound, a second bismaleimide compound, and a cyanate ester monomer to form a curable resin composition; and (ii) curing the curable resin composition to form a liquid processible bismaleimide-triazine resin.

Step (i) of the method of the present disclosure involves mixing a first bismaleimide compound, a second bismaleimide compound, and a cyanate ester monomer to form a curable resin composition of the present disclosure.

In that step the first bismaleimide compound, second bismaleimide compound, and the cyanate ester monomer may be any of those described above.

The mixing can be performed by any art known mixing method.

In some embodiments the resin composition is partially cured to prevent or minimise phase separation during the curing step. In some embodiments the resin composition is partially cured to prevent or minimise phase separation during the curing step and/or to minimise volatilisation.

The resin composition may be degassed after the partial curing, e.g. under vacuum at 90° C. for 30 minutes or until there are no visual bubbles in the mixture, to remove entrapped air before the curing step to prevent or at least minimise the formation voids in the cured product.

Step (ii) of the method of the present disclosure involves curing the curable resin composition to form a liquid processible bismaleimide-triazine resin.

In that step the curing process can be performed by any art known curing method suitable for the purpose. Such methods may include autoclaving, hot pressing, or liquid moulding.

In some embodiments the curable resin compositions were cured in a convection oven using the following cure cycle; about 150° C. to about 170° C. (e.g. about 160° C.) for about 1 hour, about 190° C. to about 210° C. (e.g. about 200° C.) for about 3 hours, and about 250° C. to about 270° C. (e.g. about 260° C.) for about 1 hour to yield liquid processible bismaleimide-triazine resins of the present disclosure.

An additional or post curing step may be performed to increase the thermal stability of the resin.

As mentioned above, in some embodiments the curable resin composition of the present disclosure includes the first bismaleimide compound and the second bismaleimide compound in a eutectic mixture. This can also be advantageous in the curing of the resin composition to form a liquid processible bismaleimide-triazine resin.

For example, as the blend is in a liquid form, the first stages of processing (e.g.

degassing or infusion) is easier to achieve without polymerisation taking place, since the temperature may be maintained below the cure temperature. The polymerisation reaction is rapid at a temperature of about 160° C., with cure kinetics (activation energy, 93-96 kJ/mol-1) that are intermediate between the neat cyanate ester monomer and BMI blends.

It will be understood that the invention is not limited to the embodiments above-described and various modifications and improvements can be made without departing from the concepts described herein.

### EXAMPLES

The follow examples are provided to illustrate embodiments of the resin composition and resin blend of the present disclosure.

### Example 1

Preparation of a eutectic BMI blend

A eutectic BMI blend was prepared from:

(i) A first bismaleimide compound: bismaleimidodiphenylmethane (MDAB) supplied by Evonik Industries AG and denoted (2) in this section and in some of the drawings:

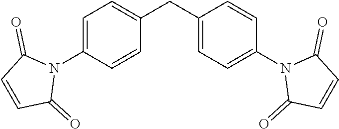 [SMILES: O=C1C=CC(=O)N1c1ccc(Cc2ccc(N3C(=O)C=CC3=O)cc2)cc1]

(ii) A second bismaleimide compound: m-xylylenebismaleimide (MXBI) supplied by Evonik Industries AG and denoted (3) in this section and in some of the drawings:

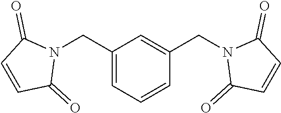 [SMILES: O=C1C=CC(=O)N1Cc1cccc(CN2C(=O)C=CC2=O)c1]

Compounds (i) and (ii) were weighed into a round bottomed flask at a 70:30 ratio by weight and heated to 140° C. The molten components were stirred for 15 minutes, before being decanted on to release film and allowed to cool to room temperature. The resulting solid BMI blend is assigned the letter E to denote eutectic.

### Example 2

Preparation of a Composition of the Present Disclosure

Compositions of the present disclosure eutectic BMI blend was prepared by weighing 1,1-bis(4-cyanatophenyl)ethane (LECy) supplied by Lonza Group AG (denoted (1) in this section and in some of the drawings) and the eutectic BMI blend (denoted E in this section and in some of the drawings) prepared in Example 1 into a round bottomed flask in the desired ratios (ranging from 100:0 to 50:50 by weight) and stirred at 120° C. for 15 minutes or until all of the BMI blend had melted to yield a liquid homogeneous composition of the present disclosure.

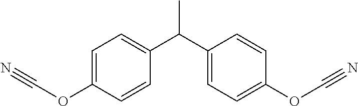 [SMILES: CC(c1ccc(OC#N)cc1)c1ccc(OC#N)cc1]

### Example 3

Preparation of a Liquid Processible Bismaleimide-Triazine Resin of the Present Disclosure

Each liquid homogeneous composition formed in Example 2 was poured into a mould, in which it was degassed for 20 minutes at 100° C. in a vacuum oven. Resin samples were cured in a convection oven using the following cure cycle; 160° C. for 1 hour, 200 ° C. for 3 hours, and 260° C. for 1 hour, unless stated, each yielding a liquid processible bismaleimide-triazine resin of the present disclosure.

### Example 4

Optimisation of a Liquid Processible Bismaleimide-Triazine Resin of the Present Disclosure

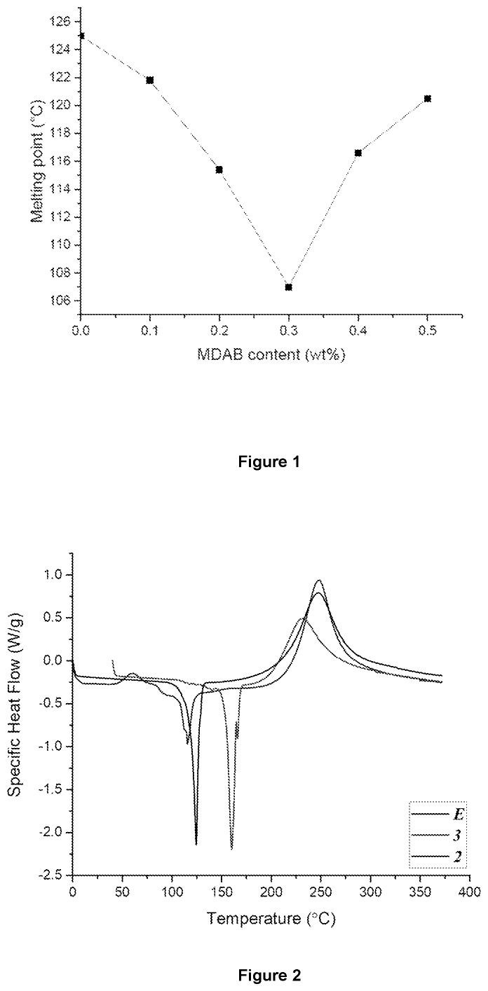

A eutectic mixture of the solid/crystalline BMI components (E) was prepared to optimise the processability of the bismaleimide-triazine resin. A series of measurements were made to establish the melting behaviour of the two BMI monomers (i) and (ii) that fused to form a liquid that was dark brown at the mixing temperature of 140° C. and formed a brown solid when cooled. A series of blends was prepared ranging in composition from the MXBI homopolymer (MXBI, 100 wt %) denoted (3)₁₀₀ to a binary blend of MXBI (50 wt %):MDAB (50 wt %) (₂)₅₀(₃)₅₀. The measured melting temperatures, determined using differential scanning calorimetry (DSC), were recorded for each binary blend. The results are shown in FIG. 1 where it can be seen the lowest melting point was achieved for a system containing 30 wt. % of the first BMI compound, MDAB, which is the eutectic, E.

FIG. 1 shows the variation in observed melting point with BMI blend composition (expressed as MDAB content, where the remainder is MXBI). The eutectic BMI blend was combined with the 1,1-bis(4-cyanatophenyl)ethane (LECy) to yield a liquid processible bismaleimide-triazine resin in proportions selected to achieve the desired processing and thermal, electrical and mechanical performance.

### Example 5

Thermal Reactivity of a Liquid Processible Bismaleimide-Triazine Resin of the Present Disclosure

Dynamic scanning calorimetry (DSC) thermograms for the eutectic mixture (E) of bismaleimidodiphenylmethane (MDAB) and m-xylylenebismaleimide (MXBI) and its corresponding constituent monomers were obtained and are shown in FIG. 2. In the Figure, E (the highest peak) denotes the eutectic mixture, 3 (the second highest peak) denotes MXBI, and 2 (the third highest peak) denotes MDAB.

Dynamic scanning calorimetry (DSC) experiments were performed using a TA DSC Q2000 instrument. Hermetically sealed Tzero aluminium pans were used, with sample masses of 10 ±2 mg. Sealing is required to prevent evaporation or sublimation from the pan. A matching, empty pan was used as the reference. Dynamic analyses were conducted with a standard heating rate of 10° C. min⁻¹. The sample cell was kept under a constant nitrogen flow of 50 cm3 min⁻¹. All DSC results are displayed with the exothermic direction pointing up the y-axis of the graph.

The melting points are clearly visible as narrow endotherms (melting point of E=107° C., MDAB (2)=124° C., MXDI (3)=157° C.) preceding broader exotherms associated with the polymerisation step (Tₘₐₓ of E=250° C., 2=250° C., 3=230° C.).

The eutectic blend, E, has two advantages over its neat BMI monomers: (i) a lower melting temperature (107° C.) than that of MDAB (124° C.) and significantly lower than that of MXBI (157° C.) means that the resin can be processed at lower temperatures; and (ii) the processing window of E (the temperature gap observed between melting and the onset of polymerisation) is improved (˜50° C.) compared to the other monomers. Processing (melting/degassing) is easier without polymerisation taking place.

### Example 6

Thermal Stability of Cured Polymers

Thermogravimetric analysis (TGA) was used to assess the thermal stability (i.e. stability in flowing nitrogen) of the eutectic mixture (E) of bismaleimidodiphenylmethane (MDAB) and m-xylylenebismaleimide (MXBI).

Thermogravimetric analysis (TGA) measurements were performed using a TA TGA Q500 instrument equipped with alumina sample pans. Experiments were undertaken in under an inert atmosphere with a N₂ flow rate of 40 cm³ min⁻¹ and a furnace heating rate of 10° C. min⁻¹. Sample masses were 15±2 mg. Char yields were measured at 800° C.

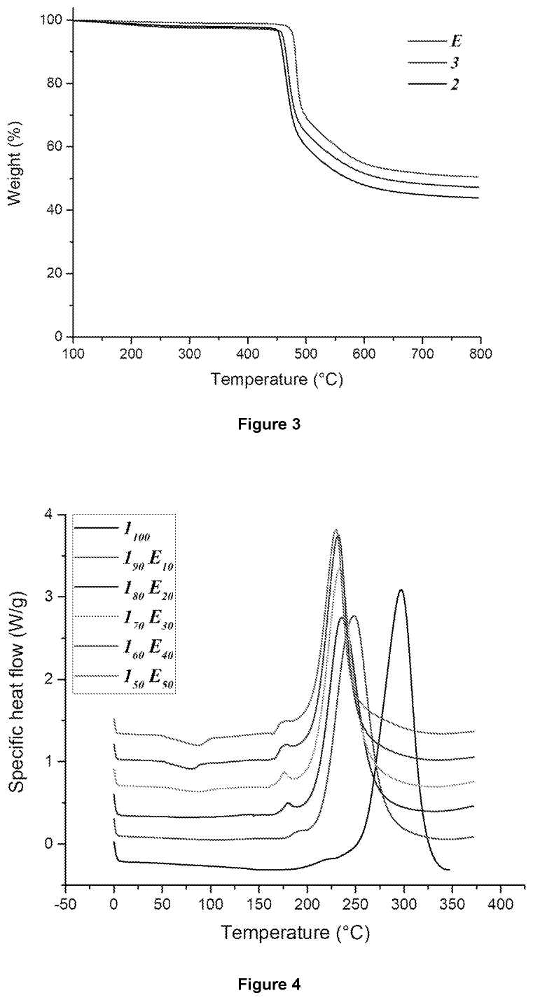

The results are shown in FIG. 3, where at 800° C. the highest line is MXBI (3), then E, and the lowest line is MDAB (2). The performance of the cured eutectic blend (E) falls between those of the individual homopolymers (in terms of the onset of degradation and the char yield, the residual mass remaining at 800° C.). This shows that the addition of MXBI (3) to MDAB (2) provides the required property enhancements compared to MDAB (2) while simultaneously improving the processability compared to MXDI (3). These benefits arise alongside a reduction in MDA content of the resin, as in this instance the BMI component only contains 30 wt. % of MXDI (3).

### Example 7

Liquid Suspensions of the Uncured Resin Compositions

A series of blends were prepared containing the liquid cyanate ester (LECy) (1) and the eutectic mixture (E) of bismaleimidodiphenylmethane (MDAB) and m-xylylenebis-maleimide (MXBI). Following addition of the components the blends were observed to determine whether a single phase was formed and whether settling occurred on standing. The uncured resin compositions were homogeneous and liquid at room temperature. They were darker in colour as the BMI content increased from LECy (1)₁₀₀, LECy (1)₉₀ E₁₀, LECy (1)₈₀ E₂₀, LECy (1)_{70 E30,} LECy (1)₆₀ E₄₀, toLECy (1)₅₀ E₅₀.

### Example 8

More Reactive Cure Behaviour

Dynamic scanning calorimetry analyses were performed for the uncured resin compositions (LECy (1)ₓ E_{y}) described in Example 7 and the plots are shown in FIG. 4. The plots at 0° C. represent LECy (1)₁₀₀, LECy (1)₉₀ E₁₀, LECy (1)₈₀ E₂₀, LECy (1)₇₀ E₃₀, LECy (1)₆₀ E₄₀, to LECy (1)₅₀ E₅₀ in order from bottom to top.

The exothermic cure peak moved to a significantly lower temperature (demonstrating increased reactivity) upon the addition of the BMI component.

With just 10 wt. % of E, the temperature at the maximum of the peak (Tₘₐₓ) dropped from 297° C. to 249° C., a value similar to that of the E blend itself (Tₘₐₓ=248° C.); there was also a corresponding decrease in the onset of polymerization.

There was no visible endothermic melt peak for both the LECy (1)₉₀ E₁₀ and LECy (1)₈₀ E₂₀ resin compositions (the melt blending procedure used produced a homogenous blend that did not undergo sedimentation or crystallization of the BMI component).

Liquid processing is possible from room temperature all the way up to the onset of polymerisation at ca. 150° C., thus providing a significant manufacturing window.

The LECy (1)₈₀ E₂₀ resin composition achieved full conversion below 300° C. for all heating rates whereas the LECy (1)₁₀₀ resin composition only reached this state at temperatures 40° C. higher.

### Example 9

Liquid Processing of the Blends

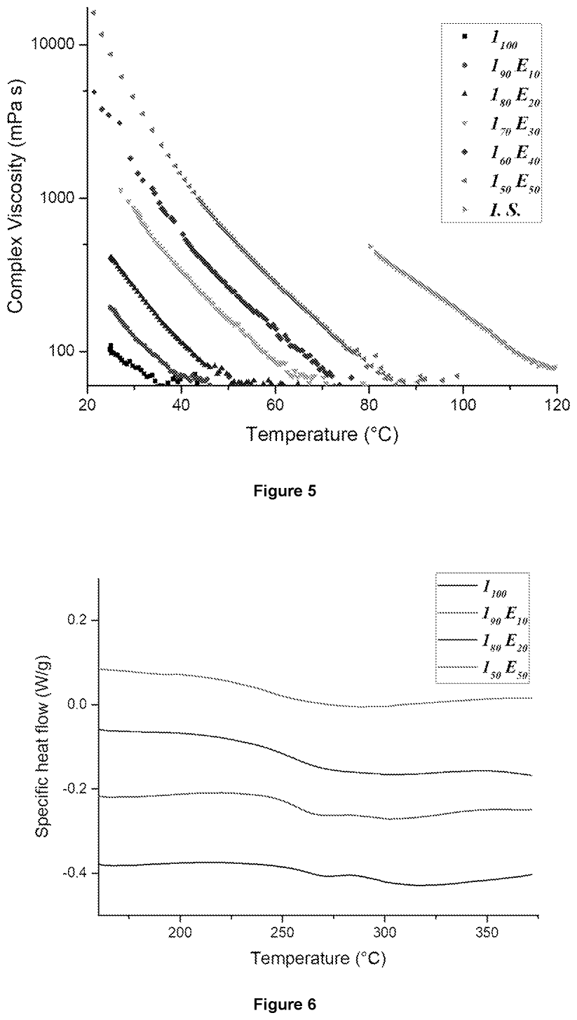

Rheology measurements (viscosity-temperature plots) were made for the uncured resin compositions (LECy (1)ₓ E_{y}) described above alongside a comparison with the industry standard Mitsubishi BT2110 resin (denoted I.S.), without solvent. The results are shown in FIG. 5. The plots from left represent LECy (1)₁₀₀, LECy (1)₉₀ E₁₀, LECy (1)₈₀ E₂₀, LECy (1)₇₀ E₃₀, LECy (1)₆₀ E₄₀, LECy (1)₅₀ E₅₀and I.S.

The rheology measurements were performed using a TA Discovery HR1 instrument equipped with parallel plate fixtures. The disposable aluminium plates were 25 mm in diameter, with a gap of 0.5 mm selected thanks to the low viscosity of the systems to be measured. A 1 Hz strain frequency was used, and an oscillation amplitude of 10% strain was selected as this fell well within the linear viscoelastic regime. A temperature ramp rate of 5° C. min-1 was used for all dynamic experiments. Gel points were recorded at the point where tan δ was equal to 1.

Mitsubishi BT2110 resin (I.S.) contains 66 wt. % monomers (˜90 mol % 2,2-bis-(cyanatophenyl)propane (BADCy) and ˜10 mol % 4,4-bis(4-maleimideophenyl)methane (MBAB)) and 34 wt. % solvents (77.0 mol % 2-butanone (MEK), 18.5 mol % N,N-dimethyl-formamide (DMF), 2.49 mol % N-methylpyrrolidinone (NMP), 1.71 mol % aniline, 0.16 mol % chlorobenzene, 0.04 mol % N,N-dimethylacetamide, and 0.03 mol % toluene). Other characterising properties include: BMI content 10 wt. %, glass transition temperate T_{g} 230-260° C., moisture absorption 1.0-3.0 wt. %, dissipation factor D_{f} 0.0003-0.007, and dielectric constant Dₖ 3.0-3.3.

It is expected that incorporation of a BMI component will increase the viscosity of the system, with it essentially dissolving in the liquid cyanate component. As E is added into the blend there is a concomitant increase in viscosity, increasing by two whole orders of magnitude by the time the 1₅₀ E₅₀ system is reached, but the systems are still inherently processable (1000 mPa·s is generally recognised as the upper practical limit at the desired processing temperature).

Uncured resin blend viscosity remained below 1000 mPa·s at room temperature up until 1₈₀ E₂₀, however even for the 1₅₀ E₅₀, blend a temperature as low as 43° C. would render the resin processable.

The industrial standard BT system (I.S.) remained solid until 80° C. (it can be solvated using high boiling, harmful solvents such as dimethylacetamide and dimethyl-formamide), almost double the temperature of the most viscous of the blends.

### Example 10

Optimisation of a Liquid Processible Bismaleimide-Triazine Resins

Selected blends (LECy (1)₁₀₀, LECy (1)₉₀ E₁₀, LECy (1)₈₀ E₂₀ and LECy (1)₅₀ E₅₀) were examined to determine the cured neat resin properties. All cured systems were homogeneous, indicating that there was no phase separation between the different components, with no defects or voids observed.

The colour of the material darkened with increasing BMI content.

The glass transition temperatures (T_{g} of the cured materials were determined using DSC and the results are shown in FIG. 6. The plots from bottom to top are those for LECy (1)₁₀₀, LECy (1)₉₀ E₁₀, LECy (1)₈₀ E₂₀ and LECy (1)₅₀ E₅₀. They are offset vertically for clarity.

The addition of the BMI component to the LECy system resulted in a reduction in glass transition temperature. Without wishing to be bound by theory, this may be caused by competition between the two different polymer networks preventing either from forming to their full extent, resulting in a lower crosslink density. In each case the degree of cure was greater than 95% despite containing no catalyst.

Rescan data showing the T_{g} values are given in Table 1 below.

TABLE 1
Summary of DSC data for the cured resin blends

| Blend | T_{g} midpoint (° C.) | T_{g} range (° C.) |
|---|---|---|
| LECy (1)₁₀₀ | 263 | 252-268 |
| LECy (1)₉₀E₁₀ | 258 | 247-265 |
| LECy (1)₈₀ E₂₀ | 257 | 243-268 |
| LECy (1)₅₀ E₅₀ | 243 | 227-258 |

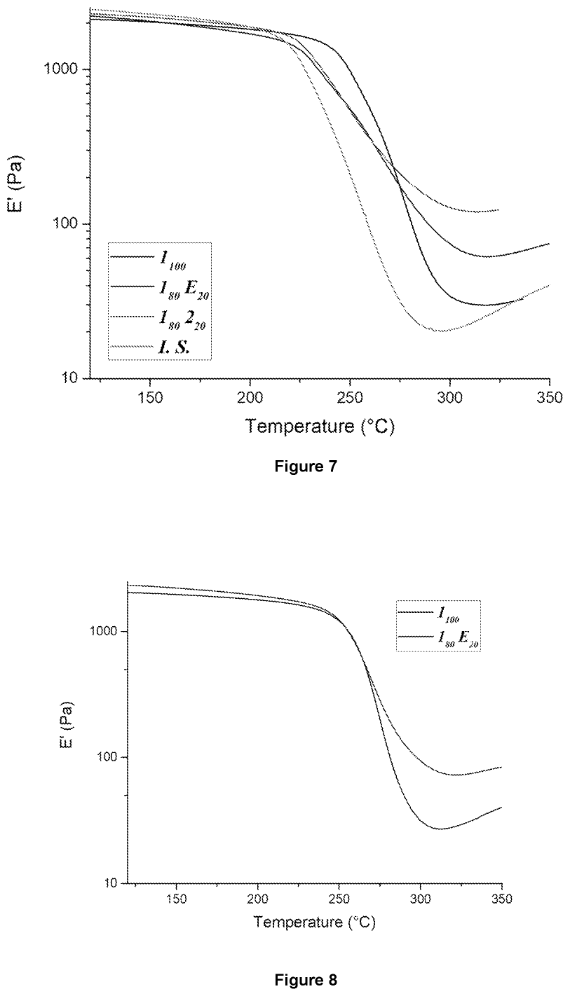

Dynamic mechanical thermal analysis data for resin blends, LECy (1)₁₀₀, LECy (1)₈₀ E₂₀, LECy (1)₈₀ MDAB (2)₂₀, and I.S., are shown in FIG. 7 and summarised in Table 2. In the figure the plots at 300° C. from top to bottom are for LECy (1)₈₀ MDAB(2)₂₀, LECy (1)₈₀ E₂₀, LECy (1)₁₀₀, and I.S.

Dynamic mechanical thermal analysis (DMTA) measurements were performed using a TA DMA Q800 instrument equipped with a single cantilever bending fixture. The dimensions of the specimen bars were ca. 2.5 mm×10 mm×35 mm, with a displacement amplitude of 15 μm, a frequency of 1 Hz, and a temperature ramp rate of 5° C. min⁻¹. Temperatures for this test ranged from 25° C. to 360° C. The glass transition temperature was determined using three different features of the resulting data plots: the onset of storage modulus (E′) decrease, the peak of the loss modulus (E″), and the peak of the tan δ curve.

TABLE 2
Key quantitative data ascertained from DMA experiments.

| | T_{g} (° C.) | | | |
|---|---|---|---|---|
| Resin | E′ at 120° C. (MPa) | E′ onset | E″ peak | tan(δ) peak |
| LECy (1)100 | 2111 | 241 | 251 | 281 |
| LECy (1)₈₀ E₂₀ | 2215 | 223 | 231 | 275 |
| LECy (1)₈₀ | 2289 | 224 | 234 | 275 |
| (MDAB/DBA)₂₀ | | | | |
| I.S. | 2440 | 210 | 226 | 264 |

MDAB/DBA being a commercially available toughened BMI that is a binary blend of MDAB and 3,3′-diallylbisphenol A (DBA).

The best performing system from a temperature perspective was the neat cyanate ester (CE) resin (LECy (1)₁₀₀), with all of the BT resins having lower T_{g} values. However, both systems investigated here exhibited superior performance to the industrial standard (I.S.).

The E containing blend had comparable properties to the MDAB (2) containing system (replacing 60% by weight of monomer MDAB, whose precursor has carcinogenicity issues, with E did not appear to significantly alter the characteristics of the cured resin).

While the BT systems showed inferior temperature properties to the neat CE resin, the stiffness of the material was enhanced, increasing for all examples.

A modified (more demanding) cure cycle was applied: 170° C. for 2 hours, 200° C. for 4 hours, 220° C. for 2 hours, and 250° C. for 4 hours in an inert atmosphere and the DMTA data for these newly cured blends are presented in FIG. 8 and Table 3. In the figure at both 150° C. and 300° C. the upper plot is for LECy (1)₈₀ E₂₀ and the lower plot is for LECy (1)₁₀₀.

TABLE 3
DMA data for materials cured using cure cycle (a) and (b)
T_{g} (° C.)

| Cure | | E’ at 120° C. | E’ | E” | tan(δ) |
|---|---|---|---|---|---|
| cycle | Resin | (MPa) | onset | peak | peak |
| (a) | LECy (1)₁₀₀ | 2038 | 228 | 237 | 274 |
| (a) | LECy (1)₉₀ E₁₀ | 2226 | 218 | 226 | 269 |
| (a) | LECy (1)₈₀ E₂₀ | 2108 | 216 | 225 | 274 |
| (a) | LECy (1)₅₀ E₅₀ | 2328 | 197 | 210 | 251 |
| (a) | I. S. | 2171 | 205 | 211 | 267 |
| (b) | LECy (1)₁₀₀ | | 254 | 265 | 281 |
| (b) | LECy (1)₈₀ E₂₀ | | 251 | 262 | 280 |

The results show when using the alternative cure cycle, the properties of the LECy (1)₁₀₀ and LECy (1)₈₀ E₂₀ systems were remarkably similar.

The addition of the much cheaper BMI component (typically 1/10^{th} the cost of cyanate ester) maintained temperature performance whilst improving the stiffness of the material if appropriate cure cycles are used.

The use of an inert atmosphere was critical for the last stage of cure to prevent unwanted thermal degradation.

### Example 11

Thermal Stability of Liquid Processible Bismaleimide-Triazine Resins

Following the DMTA experiments described in the Example 10, the samples were examined visually. The LECy (1)ₓ E_{y} blends became darker when heated to 360° C. and maintained their shape with no sign of outgassing.

Under the same conditions, the industrial standard (Mitsubishi BT2110) resin) had blackened entirely, with severe blistering noted on both surfaces.

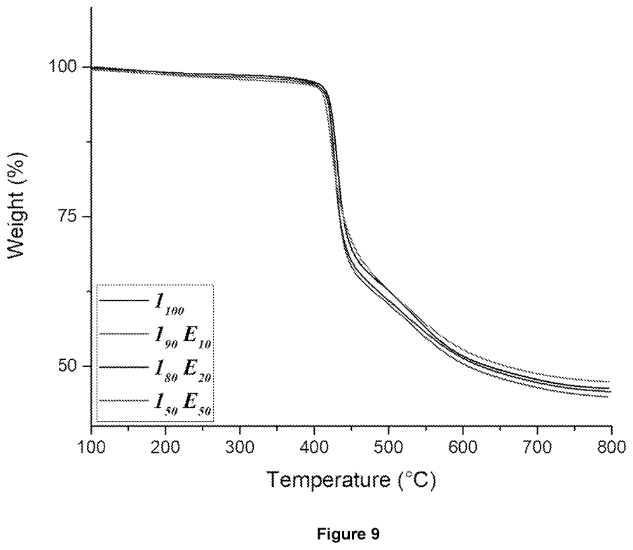

The results of thermogravimetric analysis (TGA) of the aforementioned cured LPBT resin systems in a nitrogen atmosphere are shown in FIG. 9 and Table 4. In the figure the plots at 450° C. and 800° C. from top to bottom are for LECy (¹)₅₀ E₅₀, LECy (1)₁₀₀, LECy (1)₈₀ E₂₀, and LECy (1)₉₀ E₁₀.

TABLE 4
TGA data for cured BT blends

| Blend | T_{5%} (° C.) | Tₘₐₓ (° C.) | Char Yield @ 800° C. |
|---|---|---|---|
| LECy (1)₁₀₀ | 419 | 430 | 46 |
| LECy (1)₉₀ E₁₀ | 416 | 429 | 45 |
| LECy (1)₈₀ E₂₀ | 417 | 425 | 46 |
| LECy (1)₅₀ E₅₀ | 416 | 423 | 47 |

The temperatures at which the materials lost 5% and 10% of their mass, T_{5%} and T_{10%}, were comparable across the blends (3° K range).

The temperatures at which the maximum rate of mass loss was observed, Tₘₐₓ, were comparable across the blends (7° K range).

Char yields (mass remaining at 800° C.) were practically the same.

From this and the previous Examples it is demonstrated that the combination of a low viscosity commercially available cyanate ester monomer with a eutectic blend of two commercially available bismaleimides provided a family of thermoset polymers with low viscosities (<1000 mPa·s) at low temperatures, making laminate infusion feasible at temperatures below 50° C. (and in some cases at ambient temperature).

The polymerisation reaction was rapid at a temperature of 160° C., with cure kinetics (activation energy, 93-96 kJ/mol-1) that are intermediate between the neat cyanate ester monomer and BMI blends. The blends containing low BMI contents were shown to be particularly reactive. This, coupled with low viscosity at room temperature, makes them particularly suitable for liquid composite moulding processes.

When compared with the industry standard (commercially available Mitsubishi BT2110), the physical and mechanical properties of the cured resin blends were shown to be highly favourable with the potential to achieve desirable glass-transition temperatures (T_{g}), storage moduli, and thermal stabilities.

1. A curable resin composition comprising:
(a) a first bismaleimide compound;
(b) a second bismaleimide compound, which is different from the first bismaleimide compound; and
(c) a cyanate ester monomer.

2. The curable resin composition of claim 1, wherein the first bismaleimide compound is a compound of formula I: 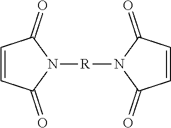
where R is —Ar¹—R¹—Ar²—, wherein Ar¹ is C₆-C₁₀-aryl, R¹ is C₁-C₁₀-alkylene, and Ar² is C₆-C₁₀-aryl.

3. The curable resin composition of claim 2, wherein the first bismaleimide compound is a compound of formula Ia:

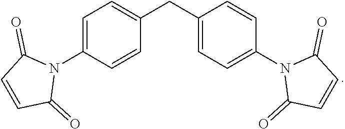 [SMILES: O=C1C=CC(=O)N1c1ccc(Cc2ccc(N3C(=O)C=CC3=O)cc2)cc1]

4. The curable resin composition of claim 1, wherein the second bismaleimide compound is a compound of formula I: 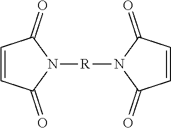
where R is —R²—Ar³—R³—, wherein R² is C₁-C₁₀-alkylene, Ar³ is C₆-C₁₀-aryl, and R³ is C₁-C₁₀-alkylene.

5. The curable resin composition of claim 4, wherein the second bismaleimide compound is a compound of formula IIa:

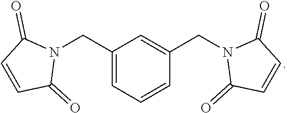 [SMILES: O=C1C=CC(=O)N1Cc1cccc(CN2C(=O)C=CC2=O)c1]

6. The curable resin composition of claim 1, wherein the first bismaleimide compound and the second bismaleimide compound are present in a eutectic mixture.

7. The curable resin composition of claim 1, wherein the cyanate ester monomer is a compound of formula III:
N≡C—O—Ar⁴—R⁴—Ar⁵—O—C≡N
wherein Ar⁴ is C₆-C₁₀-aryl, R⁴ is C₁-C₁₀-alkylene, and R⁵ is C₁-C₁₀-alkylene.

8. The curable resin composition of claim 7, wherein R⁵ is —C(H)(C₁-C₄-alkyl)-.

9. The curable resin composition of claim 8, wherein R⁵ is —C(H)(CH₃)—.

10. The curable resin composition of claim 9, wherein the cyanate ester monomer is a compound of formula Ma:

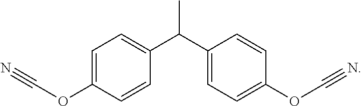 [SMILES: CC(c1ccc(OC#N)cc1)c1ccc(OC#N)cc1]

11. The curable resin composition of claim 1, wherein the curable resin composition is free of any solvent.

12. The curable resin composition of claim 1, further comprising a catalyst.

13. The curable resin composition of claim 10, wherein the catalyst is bis(acetylacetonato)copper(II).

14. A liquid processible bismaleimide-triazine resin comprising a cured curable resin composition of claim 1.

15. A method of preparing a liquid processible bismaleimide-triazine resin of claim 14, the method comprising the steps of:
mixing a first bismaleimide compound, a second bismaleimide compound that is different from the first bismaleimide compound, and a cyanate ester monomer to form a curable resin composition; and
curing the curable resin composition to form a liquid processible bismaleimide-triazine resin.

16. The method of claim 15, wherein the curable resin composition is cured at about 150° C. to about 170° C.

17. The method of claim 16, wherein the curable resin composition is cured at about 160° C.

18. The method of claim 15, wherein the curable resin composition is cured at about 150° C. to about 170° C. for about 1 hour, about 190° C. to about 210° C. for about 3 hours, and about 250° C. to about 270° C. for about 1 hour.

19. The method of claim 18, wherein the curable resin composition is cured at about 160° C. for about 1 hour, at about 200° C. for about 3 hours, and at about 260° C. for about 1 hour.
